(19) United States
(12) Patent Application Publication
(10) Pub. No.: US 2006/0031370 A1
(43) Pub. Date: Feb. 9, 2006

(54) Policy enhanced instant messenger client with dynamic interface

(75) Inventors: Ruthie D. Lyle, Durham, NC (US); Veronique Moses, Raleigh, NC (US); Fonda J. Daniels, Cary, NC (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: International Business Machines Corporation, Armonk, NY (US)

(21) Appl. No.: 10/881,087

(22) Filed: Jun. 30, 2004

(51) Int. Cl. G06F 15/16

(52) U.S. Cl. 709/207

(57) ABSTRACT

Described is a method for indicating a communication availability of a first instant messaging user to a second instant messaging user. A graphical parameter of a graphical feature for display on a user interface of the second instant messaging user is set in one of a plurality of states according to the communication availability of the first instant messaging user. A user state and a user location of the first instant messaging user are displayed on the user interface of the second instant messaging user in response to a selection of the displayed graphical feature by the second instant messaging user. One or more alternative communication methods for communicating with the first instant messaging user are displayed on the user interface of the second instant messaging user in accordance with a communication policy defined by the first instant messaging user.

### FIELD OF THE INVENTION

The invention relates generally to instant messaging systems. In particular, the invention relates to a method to provide an instant messaging user with the state, location, and preferred alternative communication modes of another instant messaging user.

### BACKGROUND OF THE INVENTION

Instant messaging (IM) is a service that allows a group of people to communicate efficiently with one another in real time through defined communication channels. Typically an IM user maintains a list of other IM users with whom the IM user frequently communicates. For example, one type of list referred to as a “buddy list” includes the names or identifiers for list members that may include friends, co-workers, relatives and other acquaintances of the IM user. The IM service alerts the IM user to the availability of members for communication through a graphical representation in the buddy list. For example, when a member becomes available for online communication, the IM user can receive an audible alert and a presence indicator in the buddy list changes to indicate the member is present online and thus available for communication.

In some instances, the nature of an instant message stimulates the need for follow up communication in an alternative form. For example, a “face to face” conversation or a telephone call may be preferred. The availability of IM users can change over time so that one IM user may wish to immediately converse with a second IM user but the second IM user may receive an important phone call, be in attendance at a meeting or otherwise be unavailable for online communication. The second IM user may wish not to be interrupted during the call or meeting. Alternatively, the second IM user may be actively engaged in a telephone conversation or business meeting, but may welcome an interruption by telephone or in person to handle an urgent matter with the first IM user. Unfortunately, current IM systems provide a user interface that does not permit an IM user to know the state (i.e., whether the IM user is in a meeting, engaged in a telephone call, etc.) and the physical location (e.g., office, home, or means of transportation such as a train or aircraft) of another IM user. Consequently, an IM user may be discouraged or prohibited from communicating with the other IM user if the other user is not designated online as available for communication. Moreover, the preferred alternative forms of communication for the second IM user are not known to the other IM users.

What is needed is a method for alerting an IM user with the state, location and preferred types of alternative communication of another IM user to facilitate subsequent communication between the IM users. The present invention satisfies these needs and provides additional advantages.

### SUMMARY OF THE INVENTION

In one aspect, the invention features a method for indicating a communication availability of a first instant messaging user to a second instant messaging user. A graphical parameter of a graphical feature for display on a user interface of the second instant messaging user is set in one of a plurality of states. Each state indicates a respective communication availability of an instant messaging user. The set state of the graphical parameter is determined by the communication availability of the first instant messaging user. A user state and a user location of the first instant messaging user is displayed on the user interface of the second instant messaging user in response to a selection of the displayed graphical feature by the second instant messaging user. At least one alternative communication method for communicating with the first instant messaging user is displayed on the user interface of the second instant messaging user. The one or more alternative communication methods are determined in response to the user state and the user location of the first instant messaging user according to a communication policy defined by the first instant messaging user.

In another aspect, the invention features a computer program product for indicating the communication availability of a first instant messaging user to a second instant messaging user. The computer program product includes a computer useable medium having embodied therein program code for setting a graphical parameter of a graphical feature for display on a user interface of the second instant messaging user in one of a plurality of states, program code for displaying a user state and a user location of the first instant messaging user on the user interface of the second instant messaging user in response to a selection of the displayed graphical feature by the second instant messaging user, and program code for displaying at least one alternative communication method for communicating with the first instant messaging user on the user interface of the second instant messaging user. Each state for the graphical parameter indicates a respective communication availability of an instant messaging user. The set state of the graphical parameter is determined by the communication availability of the first instant messaging user. The one or more alternative communication methods are determined in response to the user state and the user location of the first instant messaging user according to a communication policy defined by the first instant messaging user.

In still another aspect, the invention features a computer data signal embodied in a carrier wave for indicating the communication availability of a first instant messaging user to a second instant messaging user. The computer data signal includes program code for setting a graphical parameter of a graphical feature for display on a user interface of the second instant messaging user in one of a plurality of states, program code for displaying a user state and a user location of the first instant messaging user on the user interface of the second instant messaging user in response to a selection of the displayed graphical feature by the second instant messaging user, and program code for displaying at least one alternative communication method for communicating with the first instant messaging user on the user interface of the second instant messaging user. Each state for the graphical parameter indicates a respective communication availability of an instant messaging user. The set state of the graphical parameter is determined by the communication availability of the first instant messaging user. The one or more alternative communication methods are determined in response to the user state and the user location of the first instant messaging user according to a communication policy defined by the first instant messaging user.

In yet another aspect, the invention features an apparatus for indicating a communication availability of a first instant messaging user to a second instant messaging user. The apparatus includes means for setting a graphical parameter of a graphical feature for display on a user interface of the second instant messaging user in one of a plurality of states, means for displaying a user state and a user location of the first instant messaging user on the user interface of the second instant messaging user in response to a selection of the displayed graphical feature by the second instant messaging user, and means for displaying at least one alternative communication method for communicating with the first instant messaging user on the user interface of the second instant messaging user. Each state for the graphical parameter indicates a respective communication availability of an instant messaging user. The set state of the graphical parameter is determined by the communication availability of the first instant messaging user. The one or more alternative communication methods are determined in response to the user state and the user location of the first instant messaging user according to a communication policy defined by the first instant messaging user.

### BRIEF DESCRIPTION OF THE DRAWINGS

The above and further advantages of this invention may be better understood by referring to the following description in conjunction with the accompanying drawings, in which like numerals indicate like structural elements and features in the various figures. The drawings are not necessarily to scale, emphasis instead being placed upon illustrating the principles of the invention.

FIG. 1 is an illustration of a networked environment for instant messaging clients.

FIG. 2 is a graphical representation of a communication policy for an IM user in accordance with an embodiment of the invention.

FIG. 3 is an illustration of a user interface showing a user state, user location and prioritized listing of alternative communication methods for a selected IM user in accordance with an embodiment of the invention.

FIG. 4 is a flowchart representation of an embodiment of a method for indicating a communication availability of an IM user to another IM user.

### DETAILED DESCRIPTION

In brief overview the present invention relates to a method for indicating a communication availability of a first instant messaging (IM) user to a second IM user. A graphical parameter of a graphical feature displayed on a user interface of the second IM user is set in one of many possible states according to the communication availability of the first IM user. The second IM user selects the displayed graphical feature to cause a display of the user state and user location of the first IM user in the graphical interface of the second IM user. At least one alternative communication method is displayed to the second IM user in response to a communication policy of the first IM user. The communication policy defines the communication availability and associated alternative communication methods for various user states and user locations. Displayed alternative communication methods are prioritized according to preferences defined in the communication policy.

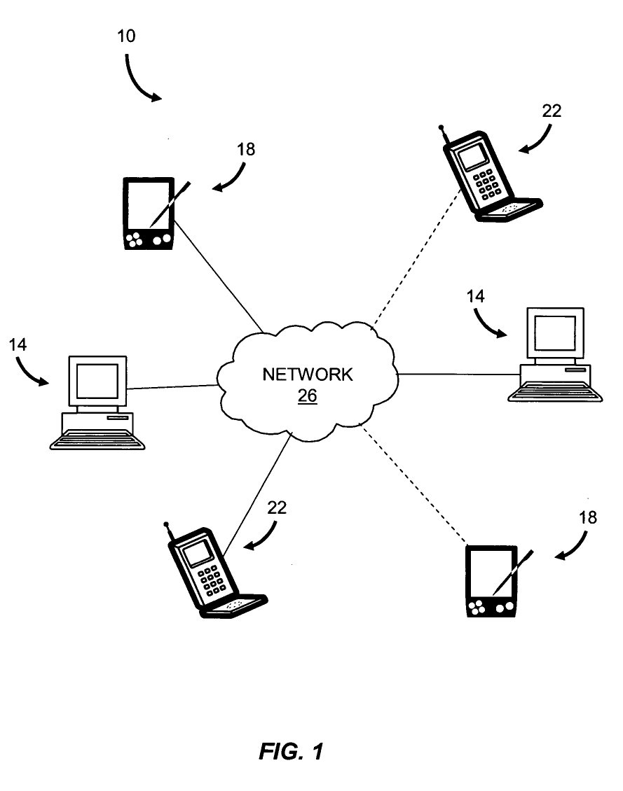

FIG. 1 illustrates a networked environment 10 in which various IM client devices communicate with each other. As illustrated, the IM client devices include personal computers (PCs) 14, personal digital assistants (PDAs) 18, and IM enabled cell phones 22 communicating over a network 26. Other devices capable of transmitting and receiving IM communications are also contemplated as IM client devices. The network 26 can be an intranet, the Internet or any network or combination of networks that supports the transmission of IM data between the client devices. Each client device includes a user interface for the presentation of text and graphics to an IM user.

The ability of an IM user to communicate rapidly with another IM user is generally limited to the time during which both IM users are online. If one IM user goes offline, another IM user cannot immediately communicate with the offline IM user. In a business environment, the availability to communicate with other employees is often of paramount importance. For example, a business situation can arise in which an employee may seek quick advice from a knowledgeable employee. Similarly, an employee can require permission from a supervisor to perform a particular task. If the knowledgeable employee or supervisor is not available in the IM session, the employee seeking the response may have to make numerous telephone calls to various locations to find the employee or supervisor. Moreover, employees working with the supervisor may shield the supervisor from these interruptions if the supervisor is engaged in a meeting or a telephone call. In some instances, the knowledgeable employee or supervisor may be willing to receive interruptions despite being in a meeting or on the telephone. Unfortunately, the seeking employee can expend significant time and effort to track down the other employee or supervisor without any guarantee of success.

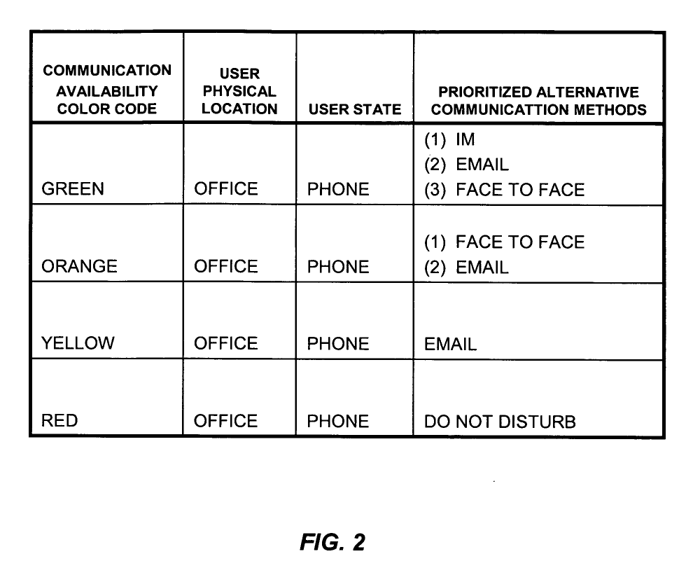

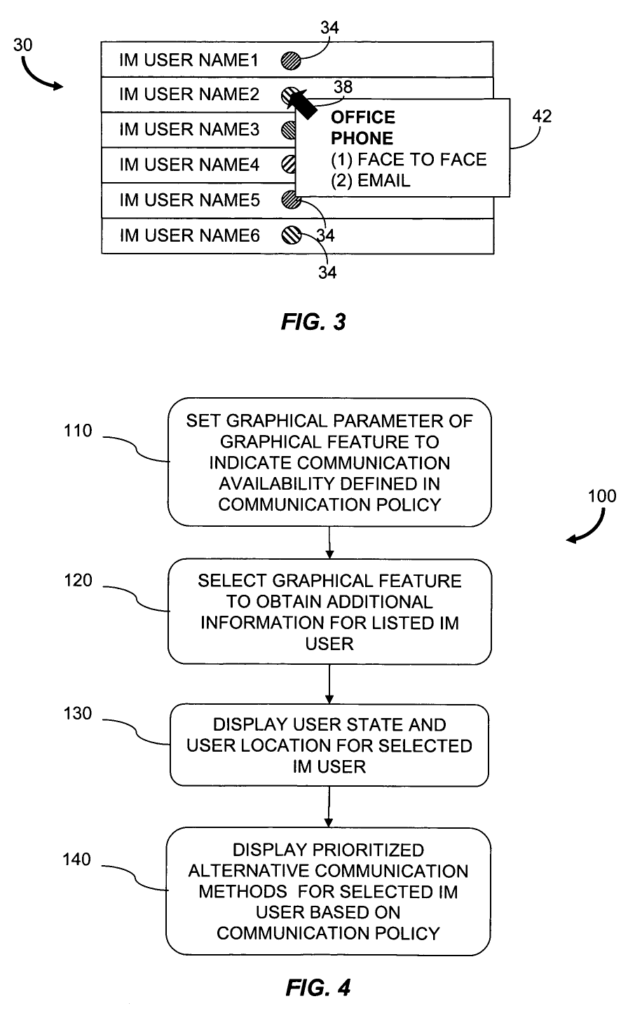

The method of the present invention provides a convenient means for an IM user to determine how to communicate with another IM user who may not be available for IM communications. Each IM user has an associated communication policy based on a user defined profile to indicate to other IM users the alternative communication preferences of the IM user. FIG. 2 illustrates an exemplary communication policy for an IM user that can be implemented with an embodiment of the method of the invention. The communication policy defines four possible communication availability designations for instances when the IM user is in the office and on the telephone. A designation is provided in the form of a graphical feature 34 for each listed IM user in the user interface 30 of an IM client device as shown in FIG. 3. As illustrated, the graphical feature 34 is a circular marking displayed near the text listing of each listed IM user. In other implementations graphical features 34 can be other shaped markings or icons associated with respective listed IM users. Alternatively, the graphical features 34 can be fonts or font sizes associated with the text of respective IM user names listed in the graphical interface. Although the illustrated communication policy shows on one type of user location and user state, it should be recognized that the communication policy can also accommodate other user locations and user states in different combinations, and that each combination can have multiple types of communication availabilities.

The illustrated communication policy shows a green designation representing a communication availability for which the IM user is willing to accept multiple forms of communications listed according to the listed priority. In this instance, the IM user's preferred communication type is IM communications. If IM communications are not used, the IM user prefers email over face to face communications. Green may indicate that the IM user is not presently involved in a high priority task or that the IM user is engaged in a telephone conversation or other communication for which interruptions are welcome. In contrast, the red designation is associated with a do not disturb condition, indicating that the IM user is unwilling to accept any form of communication from others. Orange indicates the IM user prefers face to face communications over email and yellow indicates that email is the only acceptable alternative communication.

The IM user can enter the user state and user location information manually. For example, the IM user can select a button or icon from a user interface on the IM client device. The information can be changed by the IM user real time, or may expire after a fixed time such as an eight hour period. Alternatively, the user state or user location can be automatically updated for the IM user according to a timekeeping database. The timekeeping database resides on the client device or is otherwise accessible to the client device through a communication network. Timekeeping databases can include data shared with scheduling and calendar applications utilized by the IM user. For example, information describing the time and location of a meeting is used to establish the user state and user location for the IM user for the duration of the meeting.

One or both of the user state and user location of the IM user can be determined automatically by a presence mechanism. As used herein, a presence mechanism is any system that identifies the user location or the user state of an IM user interacting with the system. In an example of such a system, a computer network management system is interrogated to determine the user location of the IM user. If the IM user is active at a network device in the associated computer network, the computer network management system reports the physical location of that network device. Alternatively, a location dependent user service is queried to retrieve information defining the user location. Location dependent services include, for example, wireless networks. As an IM user travels, communications are maintained through different network nodes. Thus it is possible to know the location of the IM user to within an area served by a single wireless communications node communicating directly with the IM client device. In another example, user state information is derived through interrogation of a telephone network. In still another example, the presence of the IM user is determined from an identification (ID) device (e.g., a smart badge) carried on the person. Radio frequency (RF) based systems, optical systems and the like can determine the room or building in which the IM user is present by reading the ID device.

Referring to FIG. 4 in conjunction with FIG. 3, an embodiment of a method 100 for indicating a communication availability of a first IM user to a second IM user is described. An IM user views a user interface 30 showing a graphical feature 34 for each listed IM user. A parameter of each graphical feature 34 is set (step 110) to designate the communication availability of the associated IM user, for example, by a specific color. The graphical feature 34 is selected (step 120) to cause the display (steps 130 and 140) of additional information, such as the user state, user location and preferred alternative communication methods of the IM user. Selection occurs, for example, by moving a user input device (e.g., mouse) so that a displayed cursor or pointer 38 is positioned over the graphical feature 34. A pop up box 42 shows the current user state (phone), user location (office) and a prioritized list of preferred alternative communication methods. The information displayed in the pop up box 42 is dynamic. Thus updated information is reported as the user state and user location of the listed IM user changes.

While the invention has been shown and described with reference to specific embodiments, it should be understood by those skilled in the art that various changes in form and detail may be made therein without departing from the spirit and scope of the invention.

What is claimed is:

1. A method for indicating a communication availability of a first instant messaging user to a second instant messaging user, the method comprising:
setting a graphical parameter of a graphical feature for display on a user interface of the second instant messaging user in one of a plurality of states, each of the states indicating a respective communication availability of an instant messaging user, the set state of the graphical parameter being determined by the communication availability of the first instant messaging user;
displaying a user state and a user location of the first instant messaging user on the user interface of the second instant messaging user in response to a selection of the displayed graphical feature by the second instant messaging user; and
displaying at least one alternative communication method for communicating with the first instant messaging user on the user interface of the second instant messaging user, the at least one alternative communication method determined in response to the user state and the user location of the first instant messaging user according to a communication policy defined by the first instant messaging user.

2. The method of claim 1 wherein the display of the at least one alternative communication method comprises a list of communication methods prioritized according to the communication policy.

3. The method of claim 1 wherein the display of the at least one alternative communication method comprises a prioritized arrangement of icons each representative of a respective alternative communication method.

4. The method of claim 1 further comprising entering the user state and the user location of the first instant messaging user through a user interface of the first instant messaging user.

5. The method of claim 1 further comprising determining at least one of the user state and the user location of the first instant messaging user from data in a user timekeeping database.

6. The method of claim 1 further comprising determining the user state of the first instant messaging user by interrogating a presence mechanism.

7. The method of claim 1 further comprising determining the user location of the first instant messaging user by interrogating a location dependent user service.

8. A computer program product for indicating the communication availability of a first instant messaging user to a second instant messaging user, the computer program product comprising a computer useable medium having embodied therein program code comprising:
program code for setting a graphical parameter of a graphical feature for display on a user interface of the second instant messaging user in one of a plurality of states, each of the states indicating a respective communication availability of an instant messaging user, the set state of the graphical parameter being determined by the communication availability of the first instant messaging user;
program code for displaying a user state and a user location of the first instant messaging user on the user interface of the second instant messaging user in response to a selection of the displayed graphical feature by the second instant messaging user; and
program code for displaying at least one alternative communication method for communicating with the first instant messaging user on the user interface of the second instant messaging user, the at least one alternative communication method determined in response to the user state and the user location of the first instant messaging user according to a communication policy defined by the first instant messaging user.

9. The computer program product of claim 8 further comprising program code for entering the user state and the user location of the first instant messaging user through a user interface of the first instant messaging user.

10. The computer program product of claim 8 further comprising program code for determining at least one of the user state and the user location of the first instant messaging user from data in a user timekeeping database.

11. The computer program product of claim 8 further comprising program code for determining the user state of the first instant messaging user by interrogating a presence mechanism.

12. The computer program product of claim 8 further comprising program code for determining the user location of the first instant messaging user by interrogating a location dependent user service.

13. A computer data signal embodied in a carrier wave for indicating the communication availability of a first instant messaging user to a second instant messaging user, the computer data signal comprising:
program code for setting a graphical parameter of a graphical feature for display on a user interface of the second instant messaging user in one of a plurality of states, each of the states indicating a respective communication availability of an instant messaging user, the set state of the graphical parameter being determined by the communication availability of the first instant messaging user;
program code for displaying a user state and a user location of the first instant messaging user on the user interface of the second instant messaging user in response to a selection of the displayed graphical feature by the second instant messaging user; and
program code for displaying at least one alternative communication method for communicating with the first instant messaging user on the user interface of the second instant messaging user, the at least one alternative communication method determined in response to the user state and the user location of the first instant messaging user according to a communication policy defined by the first instant messaging user.

14. The computer data signal of claim 13 further comprising program code for entering the user state and the user location of the first instant messaging user through a user interface of the first instant messaging user.

15. The computer data signal of claim 13 further comprising program code for determining at least one of the user state and the user location of the first instant messaging user from data in a user timekeeping database.

16. The computer data signal of claim 13 further comprising program code for determining the user state of the first instant messaging user by interrogating a presence mechanism.

17. The computer data signal of claim 13 further comprising program code for determining the user location of the first instant messaging user by interrogating a location dependent user service.

18. An apparatus for indicating a communication availability of a first instant messaging user to a second instant messaging user, the apparatus comprising:
means for setting a graphical parameter of a graphical feature for display on a user interface of the second instant messaging user in one of a plurality of states, each of the states indicating a respective communication availability of an instant messaging user, the set state of the graphical parameter being determined by the communication availability of the first instant messaging user;
means for displaying a user state and a user location of the first instant messaging user on the user interface of the second instant messaging user in response to a selection of the displayed graphical feature by the second instant messaging user; and
means for displaying at least one alternative communication method for communicating with the first instant messaging user on the user interface of the second instant messaging user, the at least one alternative communication method determined in response to the user state and the user location of the first instant messaging user according to a communication policy defined by the first instant messaging user.

19. The apparatus of claim 18 further comprising means for retrieving data from a user timekeeping database representing at least one of the user state and the user location of the first instant messaging user.

20. The apparatus of claim 18 further comprising means for interrogating a presence mechanism to determine the user state of the first instant messaging user.

21. The apparatus of claim 18 further comprising means for interrogating a location dependent service to determine the user location of the first instant messaging user.
